(19) United States
(12) Patent Application Publication
(10) Pub. No.: US 2026/0297417 A1
(43) Pub. Date: Oct. 1, 2026

(54) SAND CONSOLIDATION WITH THERMAL RESPONSIVE POLYMERS

(71) Applicant: ChampionX LLC, Sugar Land, TX (US)

(72) Inventors: Yung-Chun Lin, Sugar Land, TX (US); Maria Celeste Tria, Houston, TX (US); Kerry Charles Brinkman, Sugar Land, TX (US); Christopher Allen Waller, Houston, TX (US)

(21) Appl. No.: 19/576,676

(22) Filed: Mar. 24, 2026

Related U.S. Application Data
(60) Provisional application No. 63/777,280, filed on Mar. 25, 2025.

(51) Int. Cl. C09K 8/512

(52) U.S. Cl. CPC C09K 8/512

(57) ABSTRACT

Thermal responsive polymers are used for sand consolidation in subterranean formations. The thermal responsive polymer is reacted with a crosslinking agent to form a crosslinked thermal responsive polymer for sand consolidation in a subterranean formation.

### CROSS REFERENCE TO RELATED APPLICATIONS

This application is a non-provisional patent application claiming the benefit of, and priority to, U.S. Provisional Patent Application No. 63/777,280, filed Mar. 25, 2025, which is incorporated by reference herein in its entirety.

### FIELD OF THE DISCLOSURE

The present disclosure generally relates to sand consolidation in subterranean formations, and more particularly, to the use of thermal responsive polymers that can be crosslinked to form a crosslinked polymer for sand consolidation in subterranean formations.

### BACKGROUND

Sand particles can be present in a subterranean formation due to naturally-occurring deposits in the subterranean formation, due to introduction of sand particles during well operations (e.g., when sand particles are used as proppant during hydraulic fracturing operations), due to formation of sand particles during subterranean formation operations, or any combination of these factors. Some of these sand particles can be referred to as unconsolidated particulates, in that, the particles can be transported with production fluid from the subterranean formation and/or the fractures in the subterranean formation, into a wellbore, where the particulates can flow to the surface of the well-site with the production fluid (e.g., hydrocarbons, brine, etc.).

The presence of unconsolidated particulates in a production fluid during hydrocarbon production is undesirable, at least because the particulates can damage or abrade producing equipment, can reduce hydrocarbon production rate, and creates need for separated sand particulates from the production fluid. For example, unconsolidated particulates may migrate toward perforations and into wellbore production casings and tubing causing in-situ plugging which can significantly hinder hydrocarbon production.

Treatment techniques have been proposed, in which compositions are injected into a subterranean formation to bond with unconsolidated particulates, such as by contacting unconsolidated sand and curing into a permeable hardened mass that is not transportable by production fluid. Even with these solutions, the permeability of the hardened mass can be lower than desired, leading to a lower than desired hydrocarbon production rate.

There is an ongoing desire to find sand consolidation compositions that are options to, and improve performance over, currently available technologies.

### SUMMARY

Disclosed is a sand consolidation composition, which includes an aqueous carrier, a thermal responsive polymer (TR polymer), and a crosslinking agent.

Also disclosed is a sand consolidation composition, which includes an aqueous carrier and a crosslinked thermal responsive polymer (crosslinked TR polymer).

Also disclosed is a dual-component sand consolidation package comprising a first container containing an aqueous carrier and a TR polymer and a second container containing a crosslinking agent. The contents of the two containers can be mixed at a wellsite for introduction into a subterranean formation for sand consolidation as described herein.

Also disclosed is a method including: introducing at a wellbore i) a thermal responsive polymer (TR polymer) in an aqueous carrier and ii) a crosslinking agent into a subterranean formation, wherein the LCS temperature of the TR polymer is less than a reservoir temperature of a subterranean formation connected to the wellbore; and forming a crosslinked TR polymer.

Also disclosed is another method for synthesis of the crosslinked TR polymer disclosed herein, which can include reacting the TR polymer with a crosslinking agent to form the crosslinked TR polymer.

Other technical features may be readily apparent to one skilled in the art from the following figures, descriptions, and claims.

### DETAILED DESCRIPTION

“Curing” as used herein refers to the process by which a polymer undergoes a chemical reaction that leads to a change in its physical properties, resulting in hardening, setting, becoming insoluble in a given solvent, or becoming non-flowable. The chemical reaction leads to the creation of covalent bonds, ionic bonds, hydrogen bonds, or a combination thereof. The bonds can be induced by pH, temperature, or a combination thereof. Curing can occur between a polymer and a polymer, a polymer and a sand particle, or a combination thereof. Curing can include crosslinking, hardening, chemical bond forming, or a combination thereof.

“Lower critical solution temperature” and its variants such as “a cloud point temperature” and “a thermal transition temperature,” as used herein, include the temperature at which a polymer changes from a soluble state to an insoluble state in a given solvent.

“Thermal responsive polymer” and its variants as used herein includes polymers which remain soluble in a given solvent, forming a homogeneous solution, at temperatures below the lower critical solution temperature of the polymer. The polymer is insoluble in the given solvent at temperatures above the lower critical solution temperature of the polymer, resulting in the formation of distinct polymer-rich and solvent-rich phases.

“Reservoir” as used herein refers to a hydrocarbon and/or water containing portion of a subterranean formation. A temperature of the reservoir is referred to as the “reservoir temperature.”

“Sand particles” and “sand” as used herein can include any siliceous material that can be found in a subterranean formation, that can be formed during a subterranean formation operation, or that can be introduced to the subterranean formation (e.g., proppant to hold open fractures)).

“Subterranean formation” refers to an underground or subsea geological formation.

“Subterranean formation operation” includes, but is not limited to, a drilling operation, a stimulation operation, an acidizing operation, an acid-fracturing operation, a sand control operation, a completion operation, a scale inhibiting operation, a water-blocking operation, a clay stabilizer operation, a fracturing operation, a frac-packing operation, a gravel packing operation, a wellbore strengthening operation, a sag control operation, a remedial operation, a near-wellbore consolidation operation, a plug and abandonment operation, or any combination thereof.

“Unconsolidated particulates” as used herein refers to any particulates that may move from a subterranean formation and/or the fractures in the subterranean formation, into a wellbore, where the particulates can flow with production fluids (e.g., hydrocarbons) to the surface of the well-site. Unconsolidated particulates may include, for example, sand, gravel, proppant particulates, and/or formation fines.

“Wellbore” refers to a hole formed in a subterranean formation, including any cased portion(s), uncased portion(s), or any other tubulars in the hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

As used herein, any recited ranges of values contemplate all values within the range including the end points of the range, and are to be construed as support for claims reciting any sub-ranges having endpoints which are real number values within the recited range. By way of example, a disclosure in this specification of a range of from 10 to 15 shall be considered to support claims to values of 10, 11, 12, 13, 14, and 15, and to any of the following ranges: 10-11, 10-12, 10-13, 10-14, 10-15, 11-12, 11-13, 11-14, 11-15, 12-13; 12-14, 12-15, 13-14, 13-15, and 14-15.

Disclosed herein are sand consolidation compositions having crosslinked thermal responsive polymers (crosslinked TR polymers), and methods that form the crosslinked TR polymers for sand consolidation in a subterranean formation. The crosslinked TR polymers can be formed by reacting a crosslinking agent with a TR polymer. In oilfield applications such as those disclosed herein, the lower critical solution temperature (LCS temperature) of the TR polymer that is crosslinked is designed to be less than a reservoir temperature of the subterranean formation where the crosslinked TR polymer is applied for sand consolidation. The TR polymer can change or transition from a water-soluble state to a water-insoluble state as the temperature of the TR polymer rises above the LCS temperature while the TR polymer flows in the wellbore to the subterranean formation. The crosslinked TR polymers disclosed herein provide sand consolidation with water-based chemistry while retaining relative permeability of the consolidated sand. For example, the relative permeability of the consolidated sand with the crosslinked TR polymer is not less than 50% of the relative permeability of the unconsolidated sand.

Before crosslinking, the sand consolidation composition can include an aqueous carrier, a thermal responsive polymer (TR polymer), and a crosslinking agent. After crosslinking, the sand consolidation composition can include an aqueous carrier and a crosslinked thermal responsive polymer (crosslinked TR polymer). In practice, a dual-component sand consolidation package can be manufactured and shipped to a wellsite for mixing, where the package includes a first container comprising an aqueous carrier and a TR polymer and a second container comprising a crosslinking agent. The contents of the two containers can be mixed at a wellsite for introduction of the contents into a subterranean formation for sand consolidation as described herein.

The aqueous carrier can include or consist of water. The water can be fresh water, tap water, well water, deionized water, distilled water, produced water, municipal water, waste water such as runoff water, “gray” water, municipal waste water, treated or partially treated waste water, brackish water, produced water, sea water, or a combination thereof.

The crosslinked TR polymer can include a thermal responsive polymer component (TR polymer component) and a crosslinking component.

The TR polymer component is derived from a TR polymer comprising a homopolymer, a polymer having two or more different structural repeating units (e.g., a copolymer), a modified polymer, or a combination thereof. Non-limiting examples of the homopolymer include poly(vinyl alcohol), a polyethylene oxide (PEO) derivative, a polypropylene oxide (PPO) derivative, a poly(hydroxyalkyl (meth)acrylate), a ethyl(hydroxyethyl)cellulose, or a combination thereof. Non-limiting examples of the polymer having two or more different structural repeating units (e.g., a copolymer) comprise a poly(N-isopropylacrylamide), a poly(propylene glycol (meth)acrylate), a poly(N-vinylcaprolactam), a poly(methylvinyl ether), a poly(oligo(ethylene glycol) (meth)acrylate), or a combination thereof. Non-limiting examples of the modified polymer include a modified poly(vinyl alcohol), a modified polyacrylic acid, a modified polyvinyl acetate, or a combination thereof.

In some aspects, the TR polymer can have a molecular weight in a range of from 500 g/mol to 500,000 g/mol, alternatively, 10,000 g/mol to 35,000 g/mol.

The crosslinking component of a crosslinked TR polymer is derived from any crosslinking agent suitable for bonding to at least two functional groups (e.g., —OH groups) of the same TR polymer, bonding to a functional group (e.g., —OH group) of a first TR polymer and to a functional group (e.g., —OH group) of a second TR polymer, bonding to a functional group of one or more TR polymers and to another crosslinking agent molecule, bonding to other crosslinking agent molecules, bonding to a functional group of the first polymer and to a functional group (HO—Si—R) on a sand particle surface, bonding to a functional group of one or more TR polymers and to a functional group (HO—Si—R) of a sand particle surface, or a combination thereof. The reaction of the crosslinking agent creates a larger mass gel(s) from the TR polymers, where each larger mass gel contains one or more TR polymers in an TR polymer component and one or more crosslinking agent molecules in a crosslinking component. Non-limiting examples of the crosslinking agent include an aldehyde derivative (a mono-aldehyde, a di-aldehyde, a tri-aldehyde, a tetra-aldehyde), a carboxylic acid derivative, an isocyanate derivative, an acyl chloride derivative, an alkoxysilane derivative, an epoxy alkoxysilane derivative, an amine alkoxysilane derivative, or a combination thereof.

In aspects, the crosslinking component (in the composition as part of the crosslinked TR polymer after crosslinking) or crosslinking agent (in the composition before crosslinking the TR polymer) is present in the sand consolidation composition in a range of from 0.1 wt % to 30 wt % based on a total weight of the sand consolidation composition.

In aspects, a mass ratio of the TR polymer component to the crosslinking component present in the sand consolidation composition (after crosslinking) is in a range of from 100:1 to 1:10. In aspects, a mass ratio of the TR polymer to the crosslinking agent present in the sand consolidation composition (before crosslinking) is in a range of from 100:1 to 1:10.

In aspects, the crosslinked TR polymer is present in the sand consolidation composition in a range of from 0.1 wt % to 50 wt %, alternatively, from 0.1 wt % to 40 wt %, alternatively, from 0.1 wt % to 30 wt %, alternatively, from 0.1, to 20 wt %, alternatively, from 0.1 wt % to 15 wt %, alternatively, from 1 wt % to 15 wt %, alternatively, from 5 wt % to 15 wt %, alternatively, from 10 wt % to 15 wt % based on a total weight of the sand consolidation composition.

In some aspects, the aqueous carrier is present in the sand consolidation composition in a range of from 50 wt % to 99.9 wt %, alternatively, from 60 wt % to 99.9 wt %, alternatively, from 70 wt % to 99.9 wt %, alternatively, from 80 wt % to 99.9 wt %, alternatively, from 80 wt % to 95 wt %, alternatively, from 80 wt % to 90 wt %, alternatively, from 85 wt % to 90 wt % based on a total weight of the sand consolidation composition.

In aspects, the LCS temperature (also referred to as the cloud point temperature) of the TR polymer is in a range of from 0° C. to 200° C. In sand consolidation applications, the LCS temperature of the TR polymer is less than a reservoir temperature at the location(s) in the subterranean formation where the crosslinked TR polymer is targeted to be applied, such that the TR polymer changes to a water-insoluble state prior to arriving to or upon arrival to the location(s) where the crosslinked TR polymer is targeted for application.

The sand consolidation composition can additionally include one or more of an acid, a base, a thinning agent, or a combination thereof. Including an acid, a base, or both can create acidic, neutral, or basic conditions for forming the crosslinked TR polymers disclosed herein. The pH of the composition can be in a range of from 0 to 10, for example. The sand consolidation compositions disclosed herein can have a tunable curing time, affected by pH. For example, a crosslinking agent can crosslink the TR polymer faster under acidic conditions and slower under basic conditions. In some aspects, the pH is about neutral during change or transition of the TR polymer from water-soluble state to water-insoluble state.

Non-limiting examples of the acid can include HCl, H₂SO₄, HNO₃, citric acid, acetic acid, HF, mineral acids, organic sulfonic acids or a combination thereof. The acid can be residually left from functioning as a catalyst for synthesis of the TR polymer, can be present to create mildly acidic conditions or neutral conditions for reacting the TR polymer with the crosslinking agent, can be present for curing the crosslinked TR polymer under acidic conditions, or a combination thereof. In some aspects, the acid is present in the sand consolidation composition in a range of from 0.01 wt % to 1 wt %, alternatively, from 0.01 wt % to 0.9 wt %, alternatively, from 0.01 wt % to 0.8 wt %, alternatively, from 0.01 wt % to 0.7 wt %, alternatively, from 0.01 wt % to 0.6 wt %, alternatively, from 0.01 wt % to 0.5 wt %, alternatively, from 0.01 wt % to 0.4 wt %, alternatively, from 0.01 wt % to 0.3 wt %, alternatively, from 0.01 wt % to 0.2 wt %, alternatively, from 0.01 wt % to 0.1 wt % based on a total weight of the sand consolidation composition.

Non-limiting examples of the base can include NaOH, potassium hydroxide (KOH), calcium hydroxide (Ca(OH)₂), magnesium hydroxide (Mg(OH)₂), ammonia (NH₃), sodium bicarbonate (NaHCO₃), sodium citrate, or a combination thereof. The base can be residually left from functioning as a catalyst for synthesis of the TR polymer, can be present if the acid utilized is a strong acid, so that the base can adjust the pH of the sand consolidation composition to a mildly acidic range, such as a pH in a range of from 4 to less than 7, or to neutral conditions such as a pH of about 7. In some aspects, the base is present in the sand consolidation composition in a range of from 0.01 wt % to 1 wt %, alternatively, from 0.01 wt % to 0.9 wt %, alternatively, from 0.01 wt % to 0.8 wt %, alternatively, from 0.01 wt % to 0.7 wt %, alternatively, from 0.01 wt % to 0.6 wt %, alternatively, from 0.01 wt % to 0.5 wt % based on a total weight of the sand consolidation composition.

The thinning agent can be added to reduce the viscosity of the TR polymer in an aqueous carrier. Examples of a thinning agent include an alcohol (e.g., methanol, ethanol, isopropyl alcohol, or a combination thereof), produced water (e.g., a brine), dimethyl sulfoxide (DMSO), or a combination thereof.

This disclosure also provides a method for synthesis of the crosslinked TR polymers disclosed herein. The method generally includes reacting the TR polymer with a crosslinking agent to form a crosslinked TR polymer. Reacting can be performed in an aqueous carrier. The reacting creates a larger mass gel(s) from the TR polymers, where the larger mass gels contain one or more TR polymers in an TR polymer component and one or more crosslinking agent molecules in a crosslinking component. The reacting leads to formation of covalent bonds, ionic bonds, hydrogen bonds, or a combination thereof.

Reacting the TR polymer with a crosslinking agent can be accomplished by any order of mixing said components, for example, utilizing one or more aqueous solutions containing the reactive components.

As an example, reacting can be accomplished by providing an aqueous solution comprising the TR polymer in the water-soluble state and the crosslinking agent, and reacting the TR polymer with the crosslinking agent in the aqueous solution while the TR polymer is in the water-soluble state, the water-insoluble state, or while the TR polymer transitions from the water-soluble state to the water-insoluble state, to form a crosslinked TR polymer in the aqueous solution. The aqueous solution can be introduced into the wellbore in the methods for sand consolidation described herein.

As another example, reacting can be accomplished by providing a first aqueous solution comprising the TR polymer in the water-soluble state; combining or mixing a second aqueous solution comprising the crosslinking agent with the first aqueous solution comprising the TR polymer in the water-soluble state or in the water-insoluble state to form a third aqueous solution; and reacting the TR polymer with the crosslinking agent in the third aqueous solution while the TR polymer is in the water-soluble state, the water-insoluble state, both while the TR polymer transitions from the water-soluble state to the water-insoluble state, to form a crosslinked TR polymer in the third aqueous solution. The first aqueous solution can additionally include an acid disclosed herein, a base disclosed herein, or both. In aspects, a mass ratio of the first aqueous solution to the second aqueous solution can be in a range of from 1:1 to 100:1. The first and second aqueous solutions can be introduced separately or together into the wellbore in the methods for sand consolidation described herein.

The method for synthesis of the crosslinked TR polymers can also include forming the TR polymer that is reacted with the crosslinking agent. In aspects, forming the TR polymer can include reacting a first polymer with a modification agent or a crosslinking agent to form the TR polymer. In aspects, reacting the first polymer with the modification agent is performed in a presence of a catalyst comprising an acid or a base.

Non-limiting examples of the acid can include HCl, H₂SO₄, HNO₃, citric acid, acetic acid, HF, mineral acids, organic sulfonic acids or a combination thereof. Non-limiting examples of the base can include NaOH, potassium hydroxide (KOH), calcium hydroxide (Ca(OH)₂), magnesium hydroxide (Mg(OH)₂), ammonia (NH₃), sodium bicarbonate (NaHCO₃), sodium citrate, or a combination thereof. In aspects, reacting the first polymer with the modification agent is performed at a temperature in a range of from 0.1° C. to 200° C.

Non-limiting examples of the first polymer for synthesis of the TR polymer can include a poly(vinyl alcohol), partially hydrolyzed poly(vinyl alcohol) (60-99.9% hydrolyzed), a poly(2-hydroxyl ethyl methacrylate), a poly(ethylene glycol), a poly(oligo(ethylene glycol) methacrylate), or a combination thereof. In some aspects, the first polymer can have a molecular weight in a range of from 500 g/mol to 500,000 g/mol, alternatively, 10,000 g/mol to 35,000 g/mol.

The modification agent can be any compound suitable for forming a TR polymer by reaction of the modification agent with the first polymer. Non-limiting examples of the modification agent include an aldehyde having a formula CₙH₂ₙ₊₁CHO_{(n=0 to 10)}, a carboxylic acid, a dicarboxylic acid, an acyl chloride, a diacetyl chloride, a diisocyanate, furfuryl, or a combination thereof.

The TR polymer can thus include a first polymer component and a modification component, where the first polymer component includes a first polymer and the modification component includes one or more of an aldehyde group, a carboxylic acid group, a dicarboxylic acid group, an acyl chloride group, a diacetyl chloride group, a diisocyanate group, and furfuryl group.

A method for sand consolidation can include introducing at a wellbore i) a thermal responsive polymer (TR polymer) in an aqueous carrier at a temperature that is below the lower critical solution temperature (LCS temperature) of the TR polymer and ii) a crosslinking agent into a subterranean formation connected to the wellbore (e.g., via a wellbore formed in the subterranean formation); and forming a crosslinked TR polymer. In aspects of the method, the LCS temperature (e.g., in a range of from 0° C. to 200° C.) of the TR polymer is less than a reservoir temperature of the subterranean formation, and introducing raises the temperature of the TR polymer above the LCS temperature due to exposure of the TR polymer to the reservoir temperature, causing the TR polymer to change or transition from a water-soluble state to a water-insoluble state. In aspects of the method, the TR polymer reacts with the crosslinking agent to form the crosslinked TR polymer i) during change or transition of the TR polymer from the water-soluble state to the water-insoluble state or ii) after the TR polymer is in the water-insoluble state. In some aspects of the method, forming the sand consolidation composition occurs in-situ of a wellbore that is formed in the subterranean formation, in-situ of the subterranean formation, or both in-situ of the subterranean formation and in-situ of the wellbore. Forming the sand consolidation composition can occur while the TR polymer flows in the wellbore, while the TR polymer is stagnant in the wellbore near the sand surface where consolidation is targeted, or both.

In additional or alternative aspects of the method for sand consolidation, introducing is part of subterranean formation operation. For example, introducing can be performed during a completion operation, during a fracturing operation to reduce proppant (sand) flowback into the wellbore when fracturing pressure is discontinued on the subterranean formation, after a fracturing operation, during intervention operation, or during a remediation operation to stabilize the subterranean formation and reduce sand production. In additional or alternative aspects, introducing can be performed via conventional and/or unconventional wellbores drilled into a subterranean formation that naturally has sand that is produced (along with hydrocarbon and/or water) from the formation.

The method for sand consolidation can additionally include applying the crosslinked TR polymer to sand located in the subterranean formation. The method can additionally include curing the crosslinked TR polymer on the sand in the subterranean formation. In some aspects, curing is performed under acidic conditions (e.g., mildly acidic conditions of pH equal to or greater than 4, such as pH in a range of 4 to less than 7), while in other aspects, under neutral conditions, while in other aspects, under basic conditions. In some aspects of the method, the TR polymer changes or transitions from the water-soluble state to the water-insoluble state during introducing.

The method for sand consolidation can include any feature of the method for synthesis of the crosslinked TR polymers described herein.

### EXAMPLES

Sand consolidation compositions containing crosslinked thermal responsive polymers were prepared.

Example 1 synthesized a crosslinked TR polymer by crosslinking a modified poly(vinyl alcohol) (the TR polymer) with glutaraldehyde (the crosslinking agent). Poly(vinyl alcohol) powder was mixed with deionized water (the aqueous carrier) at a temperature of 90° C. After turning into a transparent solution, the aqueous solution was cooled to room temperature. The pH of the aqueous solution was adjusted to 4 by adding a 99% H₂SO₄ solution to the aqueous solution. Formaldehyde was then added to the aqueous solution containing poly(vinyl alcohol), and the solution was heated to 90° C. while stirring until a cloudy solution was observed, indicating that the modified poly(vinyl alcohol) had been formed as a TR polymer, with the TR polymer having a LCS temperature around 50° C. and thus being in a water-insoluble state in the solution at 90° C. The aqueous solution containing the TR polymer was cooled to room temperature. The aqueous solution turned transparent, indicating that the TR polymer had become water-soluble at room temperature, which was below the LCS temperature of about 50° C. The pH of the transparent solution was adjusted by adding diluted NaOH solution.

The modified poly(vinyl alcohol) (the TR polymer) was then crosslinked with glutaraldehyde to form the sand consolidation composition containing the crosslinked poly(vinyl alcohol) (the crosslinked TR polymer). The aqueous solution of the TR polymer was mixed with an aqueous solution of glutaraldehyde to react the glutaraldehyde with the TR polymer, forming the sand consolidation composition. The composition of the sand consolidation composition is disclosed in Table 1 below:

TABLE 1

| | % Active in the | Mass | Wt % based on Total |
|---|---|---|---|
| | Component | (g) | Weight of Composition |
| Polyvinyl alcohol | — | 100 | 9.25 |
| (99% hydrolyzed) | | | |
| Formaldehyde | 37% in water | 24 | 2.22 |
| H₂SO₄ | 99% in water | 7 | 0.65 |
| Deionized Water | — | 871.3 | 80.56 |
| NaOH | 50% in water | 9.2 | 0.85 |
| Glutaraldehyde | 50% in water | 70 | 6.47 |

The sand control performance of Example 1 composition was evaluated by applying 1 pore volume of the composition to 250 g of 100-mesh sand that was pre-packed by synthetic seawater in a cell equipped with a mesh screen. The composition was cured in contact with the sand grains at 60° C. for 24 hours. After curing, the mesh screen was removed, and 300 g of synthetic seawater was flushed through the sand pack. The effluent with loose sand grains were collected, filtered, and dried. The % sand loss was calculated using the equation:

$$Sand loss , wt \% = \frac{wt of dried sand}{250 g sand} \times 100$$

The sand consolidation composition of Example 1 exhibited 0% sand loss.

The effect on brine and oil permeability (K) of the treatment to the sandstone core plug (Table 2) was measured using coreflood experiments with the following steps:
A. Saturate core with brine
B. Measure K to brine (Initial K_{b})
C. Inject the treatment
D. Shut-in for a day at 70° C.
E. Flush with brine until pressure is stable
F. Measure K to brine (Final K_{b})
G. Flush with oil until no more brine is coming out and pressure is stable
H. Measure K to oil (Kₒ)

The retained permeability to brine was calculated as follows:

$$Retained permeability to brine = ( Final {K}_{b} / Initial {K}_{b} ) \times 100$$

The relative permeability to oil was calculated after running a blank experiment on a separate sandstone core plug without the treatment:
A. Saturate core with brine
B. Measure K to brine (K_{b-blank})
C. Flush with oil until no more H₂O comes out and P drop stabilizes
D. Measure K to oil (K_{o-blank})

$$Relative permeability to oil = ( ( {K}_{o - blank} / Initial {K}_{b - blank} ) / ( {K}_{o} / Initial {K}_{b} ) ) \times 100$$

TABLE 2

| | Initial | Final | Permeability | Retained | Relative |
|---|---|---|---|---|---|
| Test sample | K_{b}, mD | K_{b}, mD | to oil, mD | K to brine | K to oil |
| Example 1 | 1926 | 848 | 621 | 44% | 66% |
| Blank run | 1737 | — | 846 | — | — |

Example 2 synthesized a crosslinked TR polymer by crosslinking a modified poly(vinyl alcohol) (the TR polymer) with glutaraldehyde (the crosslinking agent). Poly(vinyl alcohol) powder was mixed with deionized water (the aqueous carrier) at a temperature of 90° C. After turning into a transparent solution, the aqueous solution was cooled to room temperature. The pH of the aqueous solution was adjusted to 4 by adding a 36.5% HCl solution to the aqueous solution. Butyraldehyde was then added to the aqueous solution containing poly(vinyl alcohol), and the solution was heated to 60° C. while stirring until a cloudy solution was observed, indicating that the modified poly(vinyl alcohol) had been formed as a TR polymer, with the TR polymer having a LCS temperature around 50° C. and thus being in a water-insoluble state in the solution at 60° C. The aqueous solution containing the TR polymer was cooled to room temperature. The aqueous solution turned transparent, indicating that the TR polymer had become water-soluble at room temperature, which was below the LCS temperature of about 50° C.

The modified poly(vinyl alcohol) (the TR polymer) was then crosslinked with glutaraldehyde to form the sand consolidation composition containing the crosslinked poly(vinyl alcohol) (the crosslinked TR polymer). The aqueous solution of the TR polymer was mixed with an aqueous solution of glutaraldehyde to react the glutaraldehyde with the TR polymer, forming the sand consolidation composition. The composition of the sand consolidation composition is disclosed in Table 3 below:

TABLE 3

| | % Active in the | Mass | Wt % based on Total |
|---|---|---|---|
| | Component | (g) | Weight of Composition |
| Polyvinyl alcohol | — | 100 | 9.35 |
| (99% hydrolyzed) | | | |
| Butyraldehyde | 98% in water | 10 | 0.93 |
| HCl | 36.5% in water | 2.6 | 0.24 |
| Deionized Water | — | 887.4 | 82.93 |
| Glutaraldehyde | 50% in water | 70 | 6.54 |

### ASPECTS

Aspect 1. A method comprising: introducing at a wellbore i) a thermal responsive polymer (TR polymer) in an aqueous carrier at a temperature that is below a lower critical solution temperature (LCS temperature) of the TR polymer and ii) a crosslinking agent into a subterranean formation connected to the wellbore (e.g., via a wellbore formed in the subterranean formation), wherein the LCS temperature of the TR polymer is less than a reservoir temperature of the subterranean formation; and forming a crosslinked TR polymer.

Aspect 2. The method of Aspect 1, wherein the TR polymer changes or transitions from the water-soluble state to a water-insoluble state during introducing and the TR polymer reacts with the crosslinking agent while the TR polymer is in the water-insoluble state to form the crosslinked TR polymer. For example, the increase in temperature as the TR polymer travels through a wellbore and/or into a subterranean formation can heat the TR polymer to temperature that is above the LCS temperature, causing the TR polymer to change or transition from the water-soluble statement to the water-insoluble state.

Aspect 3. The method of Aspect 1 or 2, wherein the crosslinking agent is introduced in the aqueous carrier with the TR polymer. Features of this aspect include a single mixture comprising the aqueous carrier, the TR polymer, and the crosslinking agent, that is introduced into the subterranean formation (e.g., via the wellbore).

Aspect 4. The method of Aspect 1 or 2, wherein the crosslinking agent is introduced separately from the TR polymer. Feature of this aspect include two mixtures that are introduced into the subterranean formation, a first mixture of aqueous carrier and the TR polymer and second mixture of the aqueous carrier (or another aqueous carrier) and the crosslinking agent. The first mixture can be introduced before the second mixture, or the second mixture can be introduced before the first mixture. In some cases, the first mixture and second mixture can be combined at the surface (e.g., via one or more pumps) and introduced together into the subterranean formation.

Aspect 5. The method of any one of Aspects 1 to 4, wherein forming the sand consolidation composition occurs in-situ of a wellbore extending into the subterranean formation, in-situ of the subterranean formation, or both in-situ of the subterranean formation and in-situ of the wellbore.

Aspect 6. The method of any one of Aspects 1 to 5, further comprising: applying the crosslinked TR polymer to an unconsolidated sand located in the subterranean formation; curing the crosslinked TR polymer on the unconsolidated sand located in the subterranean formation to form a consolidated sand; or applying and curing.

Aspect 7. The method of Aspect 6, wherein curing is performed under acidic conditions, neutral conditions, or basic conditions, having a pH in a range of from 0 to 10.

Aspect 8A. The method of any of Aspects 1 to 7, wherein the subterranean formation has 0% sand loss after applying.

Aspect 8B. The method of any one of Aspects 1 to 8A, wherein a relative permeability of the consolidated sand after applying is not less than 50% of a relative permeability of the unconsolidated sand.

Aspect 8C. The method of any one of Aspects 1 to 8B, wherein the LCS temperature of the TR polymer is in a range of from 0° C. to 200° C.

Aspect 9. The method of any one of Aspects 1 to 8C, wherein the TR polymer comprises a homopolymer, a polymer having two or more different structural repeating units, or a modified polymer, or a combination thereof.

Aspect 10. The method of Aspect 9, wherein: the homopolymer comprises a poly(vinyl alcohol), a partially hydrolyzed poly(vinyl alcohol), a polyethylene oxide (PEO) derivative, a polypropylene oxide (PPO) derivative, a poly(hydroxyalkyl (meth)acrylate), a ethyl(hydroxyethyl)cellulose, or a combination thereof; the polymer having two or more different structural repeating units comprises a poly(N-isopropylacrylamide), a poly(N-vinylcaprolactam), a poly(methylvinyl ether), a poly(oligo(ethylene glycol) (meth)acrylate), a poly(propylene glycol (meth)acrylate), or a combination thereof; or the modified polymer comprises a modified poly(vinyl alcohol), a modified polyacrylic acid, a modified polyvinyl acetate, or a combination thereof.

Aspect 11. The method of any one of Aspects 1 to 10, wherein the crosslinking agent comprises an aldehyde derivative (a mono-aldehyde, a di-aldehyde, a tri-aldehyde, a tetra-aldehyde), a carboxylic acid derivative, an isocyanate derivative, an acyl chloride derivative, an alkoxysilane, an epoxy alkoxysilane derivative, an amine alkoxysilane derivative, another crosslinking agent that reacts with an —OH group of the TR polymer, or a combination thereof.

Aspect 12. The method of any one of Aspects 1 to 11, wherein the crosslinked TR polymer is present in the sand consolidation composition in a range of from 0.1 wt % to 50 wt % based on a total weight of the sand consolidation composition.

Aspect 13. A sand consolidation composition comprising: an aqueous carrier comprising water; a thermal responsive polymer (TR polymer); and a crosslinking agent.

Aspect 14. The sand consolidation composition of Aspect 13, wherein the TR polymer comprises a homopolymer, a polymer having two or more different structural repeating units, or a modified polymer, or a combination thereof.

Aspect 15. The sand consolidation composition of Aspect 14, wherein: the homopolymer comprises a poly(vinyl alcohol), a partially hydrolyzed poly(vinyl alcohol), a polyethylene oxide (PEO) derivative, a polypropylene oxide (PPO) derivative, a poly(hydroxyalkyl (meth)acrylate), a ethyl(hydroxyethyl)cellulose, or a combination thereof; the polymer having two or more different structural repeating units comprises a poly(N-isopropylacrylamide), a poly(N-vinylcaprolactam), a poly(methylvinyl ether), a poly(oligo(ethylene glycol) (meth)acrylate), a poly(propylene glycol (meth)acrylate), or a combination thereof; or the modified polymer comprises a modified poly(vinyl alcohol), a modified polyacrylic acid, a modified polyvinyl acetate, or a combination thereof.

Aspect 16. The sand consolidation composition of any one of Aspects 13 to 15, wherein the crosslinking agent comprises an aldehyde derivative (a mono-aldehyde, a di-aldehyde, a tri-aldehyde, a tetra-aldehyde), a carboxylic acid derivative, an isocyanate derivative, an acyl chloride derivative, an alkoxysilane, an epoxy alkoxysilane derivative, an amine alkoxysilane derivative, another crosslinking agent, or a combination thereof.

Aspect 17. The sand consolidation composition of any one of Aspects 13 to 16, wherein the crosslinking agent is present in the sand consolidation composition in a range of from 0.1 wt % to 30 wt % based on a total weight of the sand consolidation composition.

Aspect 18. The sand consolidation composition of any one of Aspects 13 to 17, wherein a mass ratio of the TR polymer to the crosslinking agent present in the sand consolidation composition is in a range of from 100:1 to 1:10.

Aspect 19. The sand consolidation composition of any one of Aspects 13 to 18, wherein the TR polymer is present in the sand consolidation composition in a range of from 0.1 wt % to 50 wt % based on a total weight of the sand consolidation composition.

Aspect 20. The sand consolidation composition of any one of Aspects 13 to 19, wherein the aqueous carrier is present in the sand consolidation composition in a range of from 50 wt % to 99.9 wt % based on a total weight of the sand consolidation composition.

Aspect 21. The sand consolidation composition of any one of Aspects 13 to 20, further comprising: an acid, a base, or both an acid and a base, wherein the acid or the base is present in the sand consolidation composition in a range of from 0.01 wt % to 10 wt % based on a total weight of the sand consolidation composition. Features of the sand consolidation composition include having a pH in a range of from 0 to 10.

Aspect 22. A sand consolidation composition comprising: an aqueous carrier comprising water; and a crosslinked thermal responsive polymer (crosslinked TR polymer).

Aspect 23. The sand consolidation composition of Aspect 22, wherein the crosslinked TR polymer comprises a thermal responsive polymer component (TR polymer component) and a crosslinking component.

Aspect 24. The sand consolidation composition of Aspect 23, wherein the TR polymer component comprises a homopolymer, a polymer having two or more different structural repeating units, or a modified polymer, or a combination thereof.

Aspect 25. The sand consolidation composition of Aspect 24, wherein: the homopolymer comprises a poly(vinyl alcohol), a partially hydrolyzed poly(vinyl alcohol), a polyethylene oxide (PEO) derivative, a polypropylene oxide (PPO) derivative, a poly(hydroxyalkyl (meth)acrylate), a ethyl(hydroxyethyl)cellulose, or a combination thereof; the polymer having two or more different structural repeating units comprises a poly(N-isopropylacrylamide), a poly(N-vinylcaprolactam), a poly(methylvinyl ether), a poly(oligo(ethylene glycol) (meth)acrylate), a poly(propylene glycol (meth)acrylate), or a combination thereof; or the modified polymer comprises a modified poly(vinyl alcohol), a modified polyacrylic acid, a modified polyvinyl acetate, or a combination thereof.

Aspect 26. The sand consolidation composition of Aspect 23, wherein the crosslinking component comprises an aldehyde derivative (a mono-aldehyde, a di-aldehyde, a tri-aldehyde, a tetra-aldehyde), a carboxylic acid derivative, an isocyanate derivative, an acyl chloride derivative, an alkoxysilane, an epoxy alkoxysilane derivative, an amine alkoxysilane derivative, another crosslinking agent, or a combination thereof.

Aspect 27. The sand consolidation composition of any one of Aspects 23 to 26, wherein the crosslinking component is present in the sand consolidation composition in a range of from 0.1 wt % to 30 wt % based on a total weight of the sand consolidation composition.

Aspect 28. The sand consolidation composition of any one of Aspects 23 to 27, wherein a mass ratio of the TR polymer component to the crosslinking component present in the sand consolidation composition is in a range of from 100:1 to 1:10.

Aspect 29. The sand consolidation composition of any one of Aspects 22 to 28, wherein the crosslinked TR polymer is present in the sand consolidation composition in a range of from 0.1 wt % to 50 wt % based on a total weight of the sand consolidation composition.

Aspect 30. The sand consolidation composition of any one of Aspects 22 to 29, wherein the aqueous carrier is present in the sand consolidation composition in a range of from 50 wt % to 99.9 wt % based on a total weight of the sand consolidation composition.

Aspect 31. The sand consolidation composition of any one of Aspects 22 to 30, further comprising: an acid, a base, or both an acid and a base, wherein the acid or the base is present in the sand consolidation composition in a range of from 0.01 wt % to 10 wt % based on a total weight of the sand consolidation composition. Features of the sand consolidation composition include having a pH in a range of from 0 to 10.

Aspect 32. A dual-component sand consolidation package comprising a first container containing an aqueous carrier and a TR polymer and a second container containing a crosslinking agent. Features of the methods described herein can include mixing the contents of the two containers prior to introducing the contents into a subterranean formation for sand consolidation as described herein.

Aspect 33. The dual-component sand consolidation package of Aspect 32, wherein the TR polymer comprises a homopolymer, a polymer having two or more different structural repeating units, or a modified polymer, or a combination thereof.

Aspect 34. The dual-component sand consolidation package of Aspect 33, wherein: the homopolymer comprises a poly(vinyl alcohol), a partially hydrolyzed poly(vinyl alcohol), a polyethylene oxide (PEO) derivative, a polypropylene oxide (PPO) derivative, a poly(hydroxyalkyl (meth)acrylate), a ethyl(hydroxyethyl)cellulose, or a combination thereof; the polymer having two or more different structural repeating units comprises a poly(N-isopropylacrylamide), a poly(N-vinylcaprolactam), a poly(methylvinyl ether), a poly(oligo(ethylene glycol) (meth)acrylate), a poly(propylene glycol (meth)acrylate), or a combination thereof; or the modified polymer comprises a modified poly(vinyl alcohol), a modified polyacrylic acid, a modified polyvinyl acetate, or a combination thereof.

Aspect 35. The dual-component sand consolidation package of any one of Aspects 32 to 34, wherein the crosslinking agent comprises an aldehyde derivative (a mono-aldehyde, a di-aldehyde, a tri-aldehyde, a tetra-aldehyde), a carboxylic acid derivative, an isocyanate derivative, an acyl chloride derivative, an alkoxysilane, an epoxy alkoxysilane derivative, an amine alkoxysilane derivative, another crosslinking agent, or a combination thereof.

Aspect 36. The dual-component sand consolidation package of any one of Aspects 32 to 35, wherein the crosslinking agent is present in the dual-component sand consolidation package in a range of from 0.1 wt % to 30 wt % based on a total weight of the crosslinking agent, the aqueous carrier, and the TR polymer.

Aspect 37. The dual-component sand consolidation package of any one of Aspects 32 to 36, wherein a mass ratio of the TR polymer to the crosslinking agent present in the dual-component sand consolidation package is in a range of from 100:1 to 1:10.

Aspect 38. The dual-component sand consolidation package of any one of Aspects 32 to 37, wherein the TR polymer is present in the dual-component sand consolidation package in a range of from 0.1 wt % to 50 wt % based on a total weight of the crosslinking agent, the aqueous carrier, and the TR polymer.

Aspect 39. The dual-component sand consolidation package of any one of Aspects 32 to 38, wherein the aqueous carrier is present in the dual-component sand consolidation package in a range of from 50 wt % to 99.9 wt % based on a total weight of the crosslinking agent, the aqueous carrier, and the TR polymer.

Aspect 40. The dual-component sand consolidation package of any one of Aspects 32 to 39, further comprising: an acid, a base, or both an acid and a base contained in the first container, the second container, or both the first container and the second container, wherein the acid or the base is present in the dual-component sand consolidation package in a range of from 0.01 wt % to 10 wt % based on a total weight of the crosslinking agent, the aqueous carrier, and the TR polymer.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method comprising:
introducing at a wellbore i) a thermal responsive polymer (TR polymer) in an aqueous carrier at a temperature that is below a lower critical solution temperature (LCS temperature) of the TR polymer and i) a crosslinking agent, wherein the LCS temperature of the TR polymer is less than a reservoir temperature of a subterranean formation connected to the wellbore; and
forming a crosslinked TR polymer.

2. The method of claim 1, wherein the TR polymer changes or transitions from a water-soluble state to a water-insoluble state during introducing and the TR polymer reacts with the crosslinking agent while the TR polymer is in the water-insoluble state to form the crosslinked TR polymer.

3. The method of claim 1, wherein the crosslinking agent is introduced in the aqueous carrier with the TR polymer.

4. The method of claim 1, wherein the crosslinking agent is introduced separately from the TR polymer.

5. The method of claim 1, wherein forming the crosslinked TR polymer occurs in-situ of a wellbore extending into the subterranean formation, in-situ of the subterranean formation, or both in-situ of the subterranean formation and in-situ of the wellbore.

6. The method of claim 1, further comprising:
applying the crosslinked TR polymer to unconsolidated sand located in the subterranean formation; and
curing the crosslinked TR polymer on the unconsolidated sand located in the subterranean formation to form a consolidated sand.

7. The method of claim 6, wherein curing is performed under acidic conditions, neutral conditions, or basic conditions, having a pH in a range of from 0 to 10.

8. The method of claim 6, wherein the subterranean formation has 0% sand loss after applying.

9. The method of claim 6, wherein a relative permeability of the consolidated sand after applying is not less than 50% of a relative permeability of the unconsolidated sand.

10. The method of claim 1, wherein the LCS temperature of the TR polymer is in a range of from 0° C. to 200° C.

11. The method of claim 1, wherein the TR polymer comprises a homopolymer, a polymer having two or more different structural repeating units, or a modified polymer, or a combination thereof.

12. The method of claim 1, wherein the crosslinked TR polymer is present in a sand consolidation composition in a range of from 0.1 wt % to 50 wt % based on a total weight of the sand consolidation composition.

13. A sand consolidation composition comprising:
an aqueous carrier comprising water;
a thermal responsive polymer (TR polymer); and
a crosslinking agent.

14. The sand consolidation composition of claim 13, wherein the TR polymer comprises a homopolymer, a polymer having two or more different structural repeating units, or a modified polymer, or a combination thereof, wherein the TR polymer is present in the sand consolidation composition in a range of from 0.1 wt % to 50 wt % based on a total weight of the sand consolidation composition.

15. The sand consolidation composition of claim 13, wherein the crosslinking agent is present in the sand consolidation composition in a range of from 0.1 wt % to 30 wt % based on a total weight of the sand consolidation composition.

16. The sand consolidation composition of claim 13, wherein a mass ratio of the TR polymer to the crosslinking agent present in the sand consolidation composition is in a range of from 100:1 to 1:10.

17. The sand consolidation composition of claim 13, wherein the aqueous carrier is present in the sand consolidation composition in a range of from 50 wt % to 99.9 wt % based on a total weight of the sand consolidation composition.

18. The sand consolidation composition of claim 13, further comprising:
an acid, a base, or both an acid and a base,
wherein the acid or the base is present in the sand consolidation composition in a range of from 0.01 wt % to 10 wt % based on a total weight of the sand consolidation composition.

19. A sand consolidation composition comprising:
an aqueous carrier comprising water; and
a crosslinked thermal responsive polymer (crosslinked TR polymer).

20. A dual-component sand consolidation package comprising a first container containing an aqueous carrier and a TR polymer and a second container containing a crosslinking agent.
